(19) United States
(12) Patent Application Publication
(10) Pub. No.: US 2003/0005557 A1
(43) Pub. Date: Jan. 9, 2003

(54) Bundling device

(76) Inventor: Keith Robert Renn, Exton, PA (US)

Correspondence Address: Keith Robert Renn, 608 Brecknock Drive, Exton, PA, 19341, US

(21) Appl. No.: 10/163,883

(22) Filed: Jun. 6, 2002

Related U.S. Application Data
(60) Provisional application No. 60/302,812, filed on Jul. 5, 2001.

(51) Int. Cl. F16G 11/00

(52) U.S. Cl. 24/115 G; 24/115 K

(57) ABSTRACT

A continuous closed loop band device for circumferentially containing a bundle. A portion of a continuous closed-loop band is projected through a compressed spring actuated cord lock thus forming opposed first and second loop ends.

The first opposed loop end is stretched around a bundle and an end portion thereof is projected through the second opposed loop end and seated around and behind a spring actuated cord lock holding the projected end from withdraw. Means are then provided to push the cord lock away from said first loop end to shorten the circumference of said bundle encirclement thus binding said bundle

And in an alternate method the first opposed loop end of the device is circumferentially placed around a bundle. Means are then provided to push the cord lock towards said first loop end to shorten the circumference of said second loop end thus binding said bundle

### RELATED U.S. APPLICATION DATA

This application claims the benefit of U.S. Provisional Application No. 60/302,812, filed Jul. 5, 2001.

FIG. 7 is perspective view of the cord lock alone

FIG. 8A is top perspective view of the cord lock alone, in the unlocked position

FIG. 8B is top perspective view of the cord lock alone in the locked position

### DETAILED DESCRIPTION OF THE CURRENTLY PREFERRED EMBODIMENTS

Referring to the following illustrative but not limiting example will further enhance understanding of the invention.

A bundling device having a length of cord formed into a continuous closed-loop band, which is fed into and received by a cord lock forming opposed first loop and second loop ends utilized for circumferentially containing a bundle and providing a loop end for hanging about a hook or other devices utilized for hanging. Attachments can be placed on and along the continuous closed-loop band for providing a handle or additional grip for carrying, decorative purposes, or to prevent the continuous closed-loop band from inadvertently being removed from said cord lock

Turning now to the drawings, in which like reference characters refer to corresponding elements throughout the several views. FIG. 1; illustrates a bundling device 10 having a predetermined length of continuous closed loop of cord 30. An end of the continuous closed loop 30 is feed into and received by a cord lock 20 forming opposed first loop 16 and second loop 17 ends. In actual use conditions, elastomeric cord, which may be colored, having a preferred diameter of either 3 millimeters or 4 millimeters, or in a range between, has been used although other diameter cord could be used so long as it may be received by the cord lock 20 and any attachments used. Natural fiber cord or nylon cord may be used, although elastomeric cord is preferred because being able to stretch the cord 30 longitudinally while tightening the cord lock 20 enables the user to more tightly fasten the bundling device 10 about the object to be fastened. Where that object to be a fastened is an amount of cord or other material the elastomeric cord enables a tight fastening of the bundling device about a bundle, preventing cord from falling out of the bundling device 10.

Cord lock 20, as shown in these figures, has a generally spherical shaped body 26 although other body shapes, such as cylindrical, square, or rectangular, could be used. In actual use conditions, cord lock 20 is a hard plastic although other suitable materials, such as, ceramic and wood could be used.

Body 26 has an open end 21 and a closed end 22 as shown, at FIGS. 5-8, providing sidewalls 23 adjacent the open end 21. A pair of apertures 32 are formed in opposite sides of said sidewalls 23, as shown in FIG. 58. A button 22 of a size to be received by the body open end 21 is provided. Button 22 is generally cylindrical in shape having a proximal surface 34 for being manually pushed. Button 22 has a pair of openings 24 formed in walls thereof, shown at FIG. 58. A compression spring 28, as shown at FIG. 58, is attached at a first end to the distal end of the button 22 and at a second end to the inside of the closed end of body 26. In this manner, button 22 is attached to cord lock body 26. Pressure received on proximal surface 34 of button 22 compresses compression spring 28 such that button 22 is urged to a first, unlocked position, in the body 26. In this first unlocked position button openings 24 are aligned with body apertures 32 forming an orifice there through for receiving an end portion of the continuous closed-loop 30. When pressure is removed from the proximal surface 34 of the button 22, the compression spring 28 expands to its normal position such that openings 24 and apertures 32 are no longer in alignment spring 28 urging button 22 to a second, locked, position, as shown at FIGS. 5-8 locking cord 30 in a cord lock 20.

Attachments 40 provided at one or both opposed first loop 16 and second loop 17 ends of the bundling device 10 are attached, provided additional attachments can be placed on and along the continuous closed-loop cord 30 for providing a handle 40 or additional grip for carrying, providing a closed-loop end for hanging about a hook or other devices utilized for hanging, decorative purposes, or to prevent the continuous closed-loop from inadvertently being removed from said cord lock 20. In actual used conditions, acrylic hook 40 attachments have been use although other materials could be used including acrylic, ceramic and wood attachments.

The bundling device 10 is made by inserting the first or second end of said opposed first loop 16 and second loop 17 ends of the bundling device 10 into the cord lock 20 when button 22 is pressed to a first unlocked position, as in FIGS. 5A and 6A, providing an orifice through cord lock 20 such that the opposed first loop 16 and second loop 17 ends extend out the opposite sides of cord lock 20. Button 22 is released, urged by compression spring 28 to a second locked position as in FIGS. 5B and 6B locking the cord 30 into place in the cord lock 20. Attachments 40 can be attached to each opposed first loop 16 and second loop 17 ends and adhered by means of a fastening means.

In use, a first loop end 16 of the bundling device 10 is disposed in encircling relation about a bundle with said first loop end 16 projected around said second loop 17 end and said cord lock 20 and held against withdrawal there from by said cord lock 20 placed along said continuous closed-loop cord 30, whereby said projected first end 16 of said loop end being subsequently seated around and behind said cord lock and 20 correspondingly obviating inadvertent disengagement of said bundling device from about said bundle. Button 22 can be depressed and cord 30 longitudinally stretched and withdrawn through cord lock 20 until loop tension is adjusted about the bundle, or other material Use of elastomeric cord, which may be longitudinally stretched, enables a tight fit of the bundling device 10 about the bundle or other material.

In an alternate use, a first loop end 16 is expanded to its largest size, or at least to a size larger than the bundle, or other material to be fastened, by depressing button 22 on cord lock 20 and manually moving cord lock 20 to a position adjacent the second loop end 17. A bundle, or other material to be bundled, is inserted through the formed loop 16. Button 22 is again depressed and cord 30 is longitudinally stretched and withdrawn through cord lock 20 until loop is tight about the bundle, or other material. Use of elastomeric cord, which may be longitudinally stretched, enables a tight fit of the bundling device 10 about the bundle or other material. Once bundling device 10 is in the desired position, said cord lock 20 button 22 is released enabling the cord lock 20 to lock the cord 30 in place about the bundle or other material.

Bundling device 10 may be removed by reversing the above steps.

An advantage of the bundling device 10 of the present invention is that it may be successfully used on different size materials, including where there is a minimal amount of material to be fastened. Bundling device can also utilize multiple encircling methods to gain advantage of the multiple fastening means of the bundling device 10. Numerous types of attachments 40 can be attached to the bundling device 10. The bundling device 10 is easy and inexpensive to manufacture.

While the bundling device using the compressed spring actuated cord lock, herein shown and disclosed in detail, is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claim.

### TECHNICAL FIELD

The present invention relates generally to a bundle encircling elastic device for securing one or more parts of a bundle and more particularly to improvements in the bundle-securing function of the device.

### EXAMPLE OF THE PRIOR ART

It is already well known by the description and drawing illustrations of U.S. Pat. No. 5,199,135 issued on Apr. 6, 1993 to Gold to provide a binding device of a type in which a closed-loop elastic band is disposed in encircling relation about a bundle and one opposite end is projected through the other opposite and held against withdrawal therefrom by a notched dowel pin inserted in a directional path (i.e. along the length wise axis of the dowel pin) through the projected opposite end, whereby the notched dowel pin so positioned and used is effective to secure the binding device in place.

Broadly, it is an object of the present invention to provide an improved binding device of the referenced Gold type, overcoming the shortcomings of the prior art. More particularly, it is an object to utilize the advantage of a compressed spring actuated cord lock, not just to allow adjustable tension encirclement of different size bundles, but also to obviate to need for a dowel pin entirely by means of a compressed spring actuated cord lock placed on and along the continuous closed loop cord

It is also already well known by the description and drawing illustrations of U.S. Pat. No. 5,778,904 issued on Jul. 14, 1998 to Elsner to provide a fastening device of a type in which a length of cord is formed into a loop, for an encircling relation about a bundle, by passing terminal ends of the cord through a compressed spring actuated cord lock It is also the object of the present invention to provide an improved binding device of the referenced Elsner type, by overcoming the shortcomings of the prior art. More particularly, it is an object to utilize the advantage of a continuous closed loop band as opposed to a open loop length of cord to provide one or more opposed first and second loop ends for hanging about a hook or other devices utilized for hanging and provide a location for attachments placed on and along the continuous closed loop band to provide a handle or additional grip for carrying and hanging.

The description of the invention which follows, together with the accompanying drawings should not be construed as limiting the invention to example shown and described, because those skilled in the art to which this invention appertains will be able to devise other forms thereof within the ambit of the appended claim.

### BRIEF DESCRIPTION OF THE DRAWINGS

FIG. 1 is a perspective view of the bundling device

FIG. 2 is the same view as FIG. 1, with attachment hook installed

FIG. 3 is perspective view of a rope coil being loosely secured by the preferred embodiment

FIG. 3a is perspective view of a rope coil being tightly secured by the preferred embodiment

FIG. 4 is perspective view of a rope coil being loosely secured by an alternate embodiment

FIG. 5A is a top perspective view of the bundling device in the unlocked position

FIG. 5B is a top perspective view of the bundling device in the locked position

FIG. 6A is a bottom perspective view of the bundling device in the unlocked position

FIG. 6B is a bottom perspective view of the bundling device in the locked position

FIG. 7 is perspective view of the cord lock alone

FIG. 8A is top perspective view of the cord lock alone in the unlocked position

FIG. 8B is top perspective view of the cord lock alone in the locked position

### DETAILED DESCRIPTION OF THE CURRENTLY PREFERRED EMBODIMENTS

Referring to the following illustrative but not limiting example will further enhance understanding of the invention.

A bundling device having a length of cord formed into a continuous closed-loop band, which is fed into and received by a cord lock forming opposed first loop and second loop ends utilized for circumferentially containing a bundle and providing a loop end for hanging about a hook or other devices utilized for hanging. Attachments can be placed on and along the continuous closed-loop band for providing a handle or additional grip for carrying, decorative purposes, or to prevent the continuous closed-loop band from inadvertently being removed from said cord lock

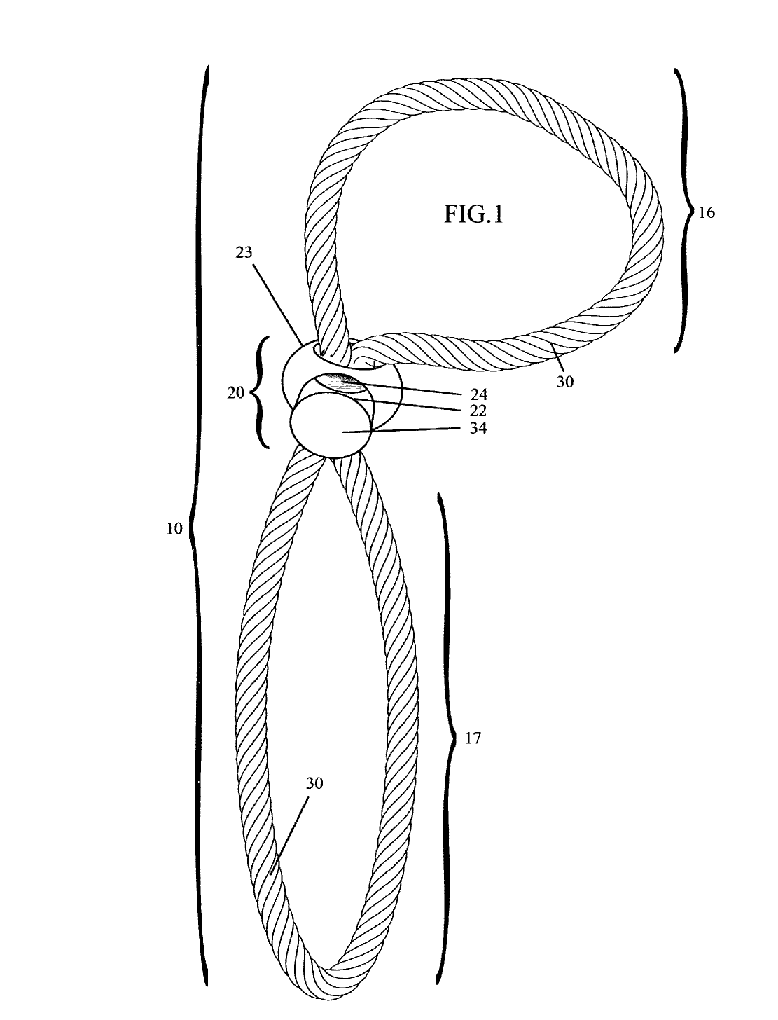

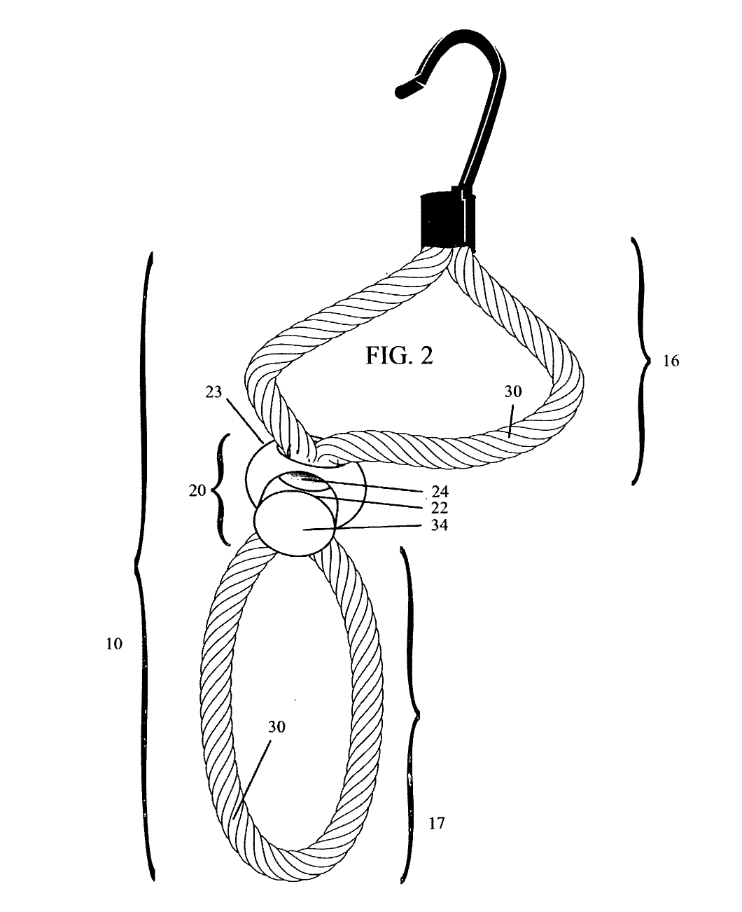

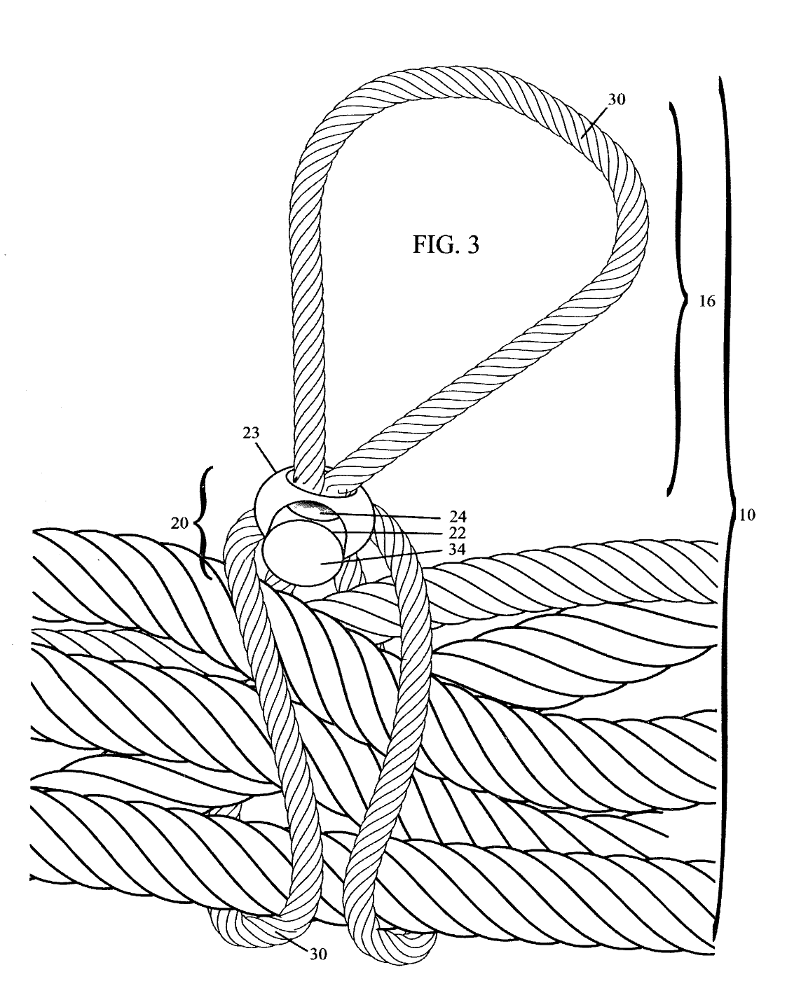

Turning now to the drawings, in which like reference characters refer to corresponding elements throughout the several views. FIG. 1; illustrates a bundling device 10 having a predetermined length of continuous closed loop of cord 30. An end of the continuous closed loop 30 is feed into and received by a cord lock 20 forming opposed first loop 16 and second loop 17 ends. In actual use conditions, elastomeric cord, which may be colored, having a preferred diameter of either 3 millimeters or 4 millimeters, or in a range between, has been used although other diameter cord could be used so long as it may be received by the cord lock 20 and any attachments used. Natural fiber cord or nylon cord may be used, although elastomeric cord is preferred because being able to stretch the cord 30 longitudinally while tightening the cord lock 20 enables the user to more tightly fasten the bundling device 10 about the object to be fastened. Where that object to be a fastened is an amount of cord or other material the elastomeric cord enables a tight fastening of the bundling device about a bundle, preventing cord from falling out of the bundling device 10.

Cord lock 20, as shown in these figures, has a generally spherical shaped body 26 although other body shapes, such as cylindrical, square, or rectangular, could be used. In actual use conditions, cord lock 20 is a hard plastic although other suitable materials, such as, ceramic and wood could be used.

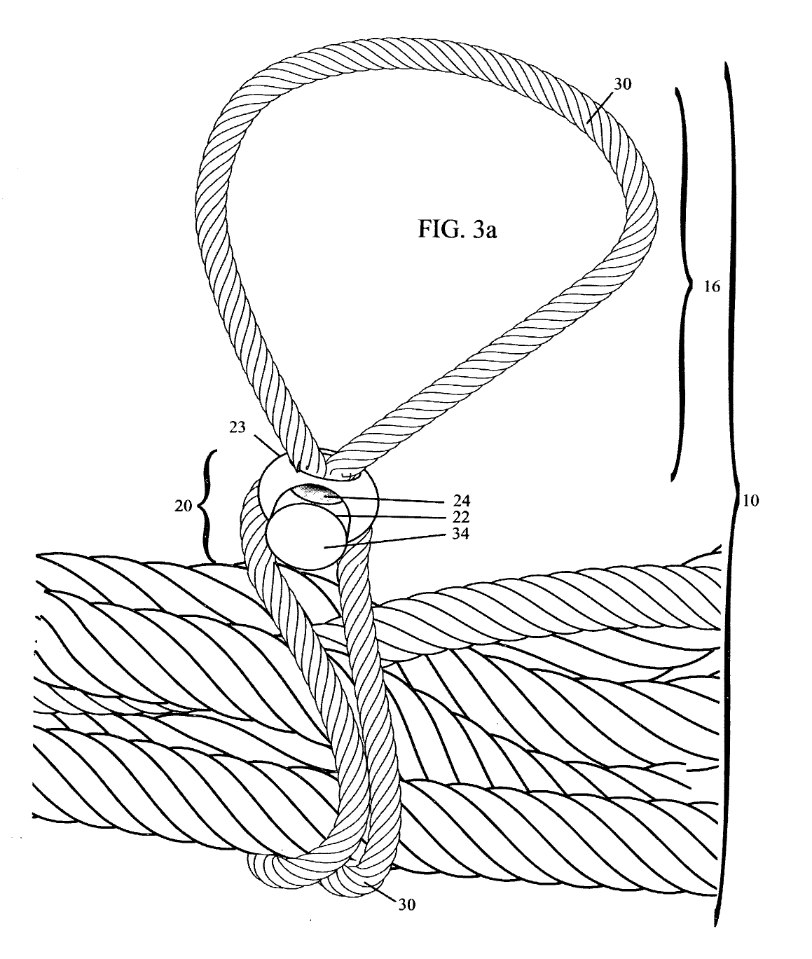

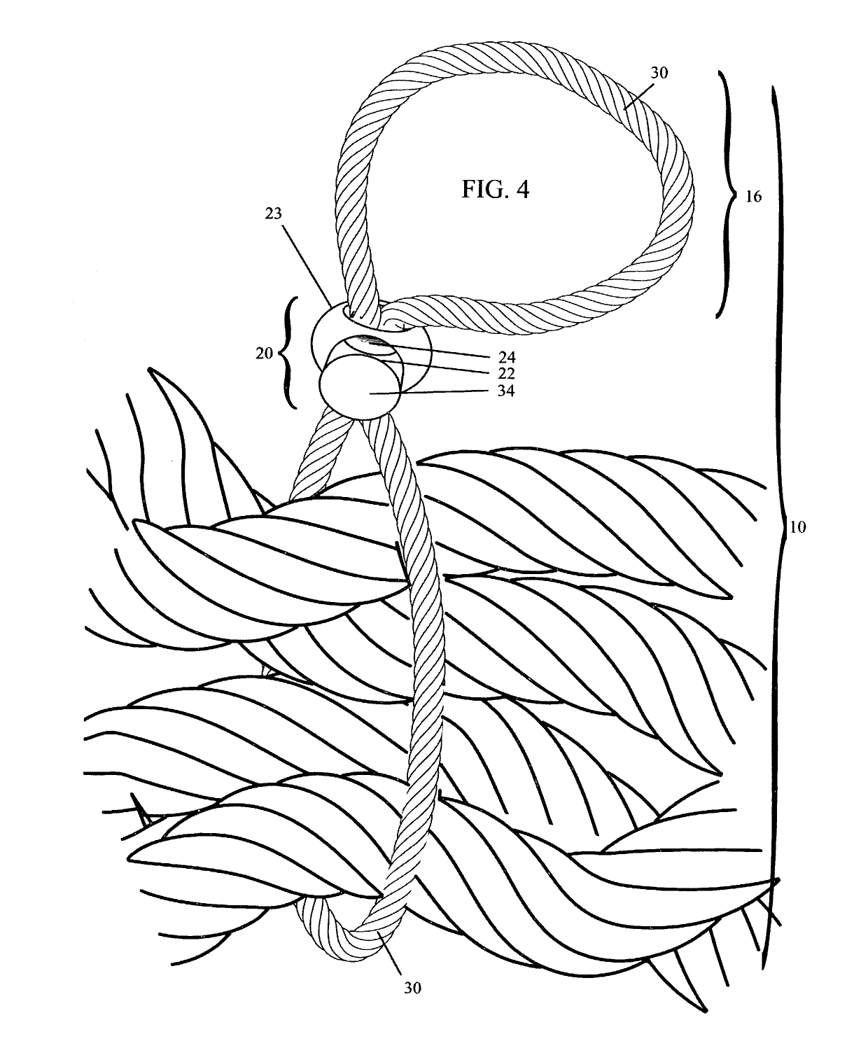

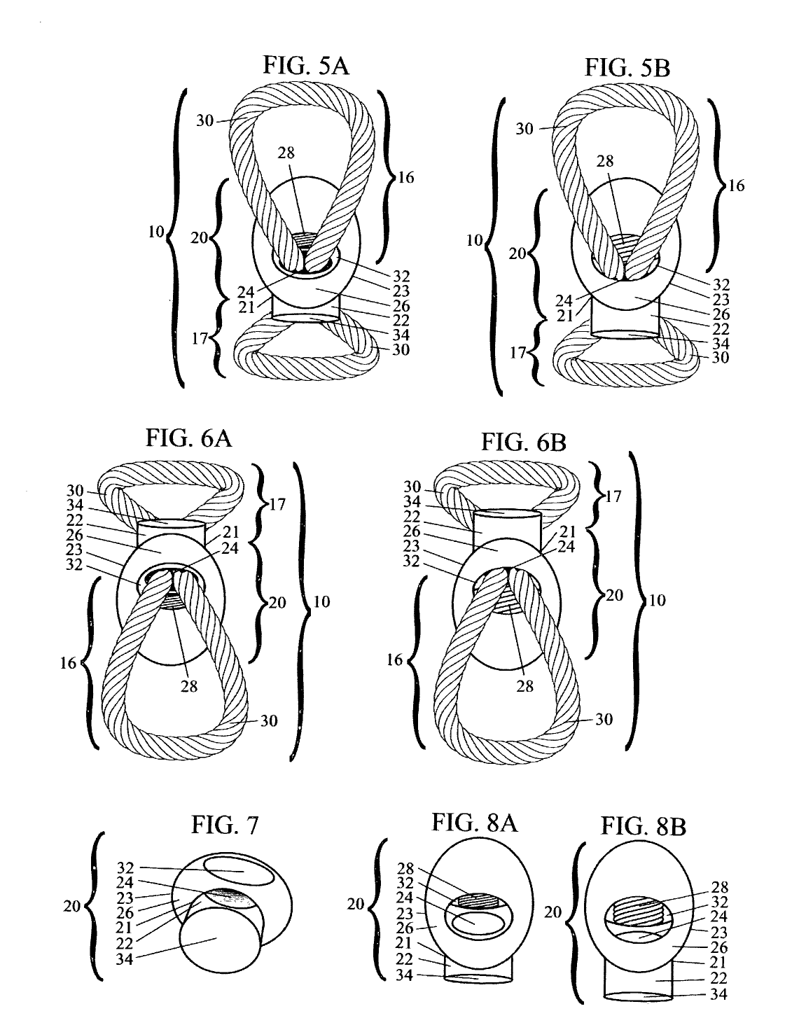

Body 26 has an open end 21 and a closed end 22 as shown, at FIGS. 5-8, providing sidewalls 23 adjacent the open end 21. A pair of apertures 32 are formed in opposite sides of said sidewalls 23, as shown in FIGS. 5-8. A button 22 of a size to be received by the body open end 21 is provided. Button 22 is generally cylindrical in shape having a proximal surface 34 for being manually pushed. Button 22 has a pair of openings 24 formed in walls thereof, shown at FIGS. 5-8. A compression spring 28, as shown at FIGS. 5-8, is attached at a first end to the distal end of the button 22 and at a second end to the inside of the closed end of body 26. In this manner, button 22 is attached to cord lock body 26. Pressure received on proximal surface 34 of button 22 compresses compression spring 28 such that button 22 is urged to a first, unlocked position, in the body 26. In this first unlocked position button openings 24 are aligned with body apertures 32 forming an orifice there through for receiving an end portion of the continuous closed-loop 30. When pressure is removed from the proximal surface 34 of the button 22, the compression spring 28 expands to it's normal position such that openings 24 and apertures 32 are no longer in alignment spring 28 urging button 22 to a second, locked, position, as shown at FIGS. 5-8 locking cord 30 in a cord lock 20.

Attachments 40 provided at one or both opposed first loop 16 and second loop 17 ends of the bundling device 10 are attached, provided additional attachments can be placed on and along the continuous closed-loop cord 30 for providing a handle 40 or additional grip for carrying, providing a closed-loop end for hanging about a hook or other devices utilized for hanging, decorative purposes, or to prevent the continuous closed-loop from inadvertently being removed from said cord lock 20. In actual used conditions, acrylic hook 40 attachments have been use although other materials could be used including acrylic, ceramic and wood attachments.

The bundling device 10 is made by inserting the first or second end of said opposed first loop 16 and second loop 17 ends of the bundling device 10 into the cord lock 20 when button 22 is pressed to a first unlocked position, as in FIGS. 5A and 6A, providing an orifice through cord lock 20 such that the opposed first loop 16 and second loop 17 ends extend out the opposite sides of cord lock 20. Button 22 is released, urged by compression spring 28 to a second locked position as in FIGS. 5B and 6B locking the cord 30 into place in the cord lock 20. Attachments 40 can be attached to each opposed first loop 16 and second loop 17 ends and adhered by means of a fastening means.

In use, a first loop end 16 of the bundling device 10 is disposed in encircling relation about a bundle with said first loop end 16 projected around said second loop 17 end and said cord lock 20 and held against withdrawal there from by said cord lock 20 placed along said continuous closed-loop cord 30, whereby said projected first end 16 of said loop end being subsequently seated around and behind said cord lock and 20 correspondingly obviating inadvertent disengagement of said bundling device from about said bundle. Button 22 can be depressed and cord 30 longitudinally stretched and withdrawn through cord lock 20 until loop tension is adjusted about the bundle, or other material Use of elastomeric cord, which may be longitudinally stretched, enables a tight fit of the bundling device 10 about the bundle or other material.

In an alternate use, a first loop end 16 is expanded to its largest size, or at least to a size larger than the bundle, or other material to be fastened, by depressing button 22 on cord lock 20 and manually moving cord lock 20 to a position adjacent the second loop end 17. A bundle, or other material to be bundled, is inserted through the formed loop 16. Button 22 is again depressed and cord 30 is longitudinally stretched and withdrawn through cord lock 20 until loop is tight about the bundle, or other material. Use of elastomeric cord, which may be longitudinally stretched, enables a tight fit of the bundling device 10 about the bundle or other material. Once bundling device 10 is in the desired position, said cord lock 20 button 22 is released enabling the cord lock 20 to lock the cord 30 in place about the bundle or other material.

Bundling device 10 may be removed by reversing the above steps.

An advantage of the bundling device 10 of the present invention is that it may be successfully used on different size materials, including where there is a minimal amount of material to be fastened. Bundling device can also utilize multiple encircling methods to gain advantage of the multiple fastening means of the bundling device 10. Numerous types of attachments 40 can be attached to the bundling device 10. The bundling device 10 is easy and inexpensive to manufacture.

While the bundling device using the compressed spring actuated cord lock, herein shown and disclosed in detail, is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claim.

What is claimed is:

1) A bundling device comprising:
a) A predetermined length of cord formed in a continuous closed loop band
b) A cord lock, having a first, unlocked position, such that a portion of a said continuous closed loop band is received by said cord lock forming opposed first and second loop ends of said continuous closed loop band, and said cord lock having a second, locked position. Whereby said continuous closed loop band is locked in position in said cord lock preventing the continuous closed loop band from inadvertently being removed from said cord lock
c) Said optional attachments threaded or otherwise attached onto said continuous closed loop band, said attachments position such that when said continuous closed loop band is formed into opposed first and second loop ends said attachments are positioned on said opposed first and second loop ends providing a handle or additional grip for carrying, providing a closed-loop end for hanging about a hook or other devices utilized for hanging, decorative purposes.
d) Means for increasing or decreasing the size of said opposed first and second loop ends.

2) The bundling device of claim 1 wherein said cord further comprises elastometric cord

3) The bundling device of claim 1 wherein said cord lock further comprises:
a) A hollow body having a blind end formed therein:
b) A pair of apertures formed in opposite side walls of said body;
c) A button received by said hollow body, said button having a proximal surface and a pair of openings formed in opposite side walls of said button:
d) A compression spring retained within said body, first end of which abuts the blind end of said body, and a second end of which is attached to a distal end of said button retaining said button within said body such that pressure applied to said proximal surface of said button compresses said compression spring withdrawing said button into said body such that said cord lock is in said first, unlocked position, where said button openings are aligned with said body apertures forming an orifice there through permitting said cord to be moved within said cord lock repositioning said cord in a predetermined position. Release of pressure upon said button such that said cord lock is in said second, locked position, wherein said apertures and openings are misaligned resulting in the locking in place of said cord within said cord lock

4) A bundling device for disposing in encircling relation about one or more strands of a bundle, with said opposed first loop end projected through the second opposed loop end and held against withdrawal therefrom by said compressed spring actuated cord lock placed on and along the continuous closed loop cord with said second loop end of said loop being subsequently seated around and behind cord lock upon the bundling encirclement under urging of said elastometric cord whereby further movement of said cord lock along said directional path is inhibited to correspondingly obviate inadvertent disengagement of said bundling device from about said bundle, comprising:
a) A predetermined length of cord formed in a continuous closed loop band
b) A cord lock, having a first, unlocked position, such that a portion of a said continuous closed loop band is received by said cord lock forming opposed first and second loop ends of said continuous closed loop band, and said cord lock having a second, locked position. Whereby said continuous closed loop band is locked in position in said cord lock preventing the continuous closed loop band from inadvertently being removed from said cord lock
c) Said optional attachments threaded or otherwise attached onto said continuous closed loop band, said attachments position such that when said continuous closed loop band is formed into opposed first and second loop ends said attachments are positioned on said opposed first and second loop ends providing a handle or additional grip for carrying, providing a closed-loop end for hanging about a hook or other devices utilized for hanging, decorative purposes.
d) Means for increasing or decreasing the size of said opposed first and second loop ends.

5) The bundling device of claim 4 wherein said cord lock further comprises:
a) A hollow body having a blind end formed therein:
b) A pair of apertures formed in opposite side walls of said body;
c) A button received by said hollow body, said button having a proximal surface and a pair of openings formed in opposite side walls of said button:
d) A compression spring retained within said body, first end of which abuts the blind end of said body, and a second end of which is attached to a distal end of said button retaining said button within said body such that pressure applied to said proximal surface of said button compresses said compression spring withdrawing said button into said body such that said cord lock is in said first, unlocked position, where said button openings are aligned with said body apertures forming an orifice there through permitting said cord to be moved within said cord lock repositioning said cord in a predetermined position. Release of pressure upon said button such that said cord lock is in said second, locked position, wherein said apertures and openings are misaligned resulting in the locking in place of said cord within said cord lock

6) A bundling device of claim 5, further comprises said opposed first and second loop ends further utilized for hanging about a hook or other devices utilized for hanging

7) The bundling device of claim 6, further comprises manually pushing said cord lock when in its first, unlocked position, along said cord for adjustable tension under urging of said elastometric cord thus decreasing the size of bundling encirclement thus tightening tension of said bundling encirclement

8) A bundling device for disposing in encircling relation about one or more strands of a bundle comprising:
a) A predetermined length of cord formed in a continuous closed loop band
b) A cord lock, having a first, unlocked position, such that a portion of a said continuous closed loop band is received by said cord lock forming opposed first and second loop ends of said continuous closed loop band, and said cord lock having a second, locked position. Whereby said continuous closed loop band is locked in position in said cord lock preventing the continuous closed loop band from inadvertently being removed from said cord lock
c) Said optional attachments threaded or otherwise attached onto said continuous closed loop band, said attachments position such that when said continuous closed loop band is formed into opposed first and second loop ends said attachments are positioned on said opposed first and second loop ends providing a handle or additional grip for carrying, providing a closed-loop end for hanging about a hook or other devices utilized for hanging, decorative purposes.
d) Means for increasing or decreasing the size of said opposed first and second loop ends.

9) The one or more strand bundling device of claim 8 wherein said cord lock further comprises:
a) A hollow body having a blind end formed therein:
b) A pair of apertures formed in opposite side walls of said body;
c) A button received by said hollow body, said button having a proximal surface and a pair of openings formed in opposite side walls of said button:
d) A compression spring retained within said body, first end of which abuts the blind end of said body, and a second end of which is attached to a distal end of said button retaining said button within said body such that pressure applied to said proximal surface of said button compresses said compression spring withdrawing said button into said body such that said cord lock is in said first, unlocked position where said button openings are aligned with said body apertures forming an orifice there through permitting said cord to be moved within said cord lock repositioning said cord in a predetermined position. Release of pressure upon said button such that said cord lock is in said second, locked position, wherein said apertures and openings are misaligned resulting in the locking in place of said cord within said cord lock

10) A bundling device of claim 9, further comprises said opposed first and second loop ends further utilized for hanging about a hook or other devices utilized for hanging

11) A bundling device of claim 10, further comprises manually pushing said cord lock when in its first, unlocked position, along said cord to enlarge or decrease the circumference of said first loop end thus shortening the circumference of said first loop end thus binding said bundle

12) A bundling device for fastening about one or more strands of a bundle, comprising:
a) A predetermined length of cord formed in a continuous closed loop band
b) A cord lock, having a first, unlocked position, such that a portion of a said continuous closed loop band is received by said cord lock forming opposed first and second loop ends of said continuous closed loop band, and said cord lock having a second, locked position. Whereby said continuous closed loop band is locked in position in said cord lock preventing the continuous closed loop band from inadvertently being removed from said cord lock
c) Said optional attachments threaded or otherwise attached onto said continuous closed loop band, said attachments position such that when said continuous closed loop band is formed into opposed first and second loop ends said attachments are positioned on said opposed first and second loop ends providing a handle or additional grip for carrying, providing a closed-loop end for hanging about a hook or other devices utilized for hanging, decorative purposes.
d) Means for increasing or decreasing the size of said opposed first and second loop ends.

13) The bundling device of claim 12. Wherein said cord lock further comprises
a) A hollow body having a blind end formed therein:
b) A pair of apertures formed in opposite side walls of said body;
c) A button received by said hollow body, said button having a proximal surface and a pair of openings formed in opposite side walls of said button:
d) A compression spring retained within said body, first end of which abuts the blind end of said body, and a second end of which is attached to a distal end of said button retaining said button within said body such that pressure applied to said proximal surface of said button compresses said compression spring withdrawing said button into said body such that said cord lock is in said first, unlocked position, where said button openings are aligned with said body apertures forming an orifice there through permitting said cord to be moved within said cord lock repositioning said cord in a predetermined position. Release of pressure upon said button such that said cord lock is in said second, locked position, wherein said apertures and openings are misaligned resulting in the locking in place of said cord within said cord lock

14) The bundling device of claim 13. Further comprises attachments provided at one or both opposed first loop and second loop ends providing a handle or additional grip for carrying, providing a hook for hanging about a hook or other devices utilized for hanging or to prevent the continuous closed-loop from inadvertently being removed from said cord lock
